(19) United States
(12) Patent Application Publication
(10) Pub. No.: US 2004/0249703 A1
(43) Pub. Date: Dec. 9, 2004

(54) Method and system for providing an incentive to customers

(76) Inventor: Stefan Weiszfeiler, Rishon LeZion (IL)

Correspondence Address: OLIFF & BERRIDGE, PLC, P.O. BOX 19928, ALEXANDRIA, VA, 22320, US

(21) Appl. No.: 10/295,956

(22) Filed: Nov. 18, 2002

(51) Int. Cl. G06F 17/60

(52) U.S. Cl. 705/14

(57) ABSTRACT

A method and system for calculating a discount to a customer at a business establishment. The method comprises determining the value of a parameter Mem PP, wherein Mem PP is a total purchase amount made by the customer at the establishment in a first time period. The value of a parameter Mem CP, wherein Mem CP is a total purchase amount made by a customer at the establishment in a second time period, is then determined, where the second time period is subsequent to the first period. The discount is then calculated using an algorithm involving Mem PP and Mem CP.

### FIELD OF THE INVENTION

The present invention relates to methods and systems for providing an incentive to consumers to patronize a business establishment.

### BACKGROUND OF THE INVENTION

In many commercial fields, a large number of business establishments compete with each other to attract and keep customers. The necessity of having to compete with each other has led to the development of various schemes that reward a customer for frequently patronizing a particular business establishment. This is particularly true in the field of grocery shopping, where many people shop several times a week, and often divide their loyalty among several competing establishments.

For example, U.S. Pat. No. 6,460,019 discloses a system and method for rewarding a customer's loyalty to a business establishment and encouraging regular customer visits by offering a progressive discount on their purchases. The value of the discount is dependant upon the customer visiting the retail establishment on a regular basis. A customer's visits are tracked, and the customer is provided with a discount that is incremented by a pre-defined value if the customer visits at least once every pre-defined period. The discount may only be incremented once in every pre-defined time period and may be negated if the customer did not visit at all during the pre-defined time period.

### SUMMARY OF THE INVENTION

The present invention provides a method and system for inducing potential customers to frequently patronize a business establishment. In accordance with the invention, customers who frequently patronize the establishment are invited to join a club of frequent customers. A member in the club is entitled to a discount on purchases made during a present time period (e.g. the present calendar month) in excess of a first predetermined threshold amount provided that the customer purchased goods or services in an amount that exceeded the first threshold amount during a recent time period (e.g. the calendar month that preceeded the present calendar month) and purchased goods or services in an amount that exceeded a third threshold value during a time period that proceeded the recent period (e.g. the calendar month that preceeded the recent calendar month). This discount is referred to herein as the member's “self-discount”. Thus, for example, a member may receive a self-discount of 4% on the value of his purchases during the present calendar month in excess of the first threshold value, provided he purchased in an amount that exceeded the first threshold value during the previous calendar month. The term “time period” is used in a broad sense and includes a single time span, or two or more discrete time spans. It should also be noted that the recent and previous time periods are not necessarily consecutive time periods.

In a preferred embodiment, a member of the club is further rewarded for convincing other individuals to patronize the establishment and to become members of the club of frequent customers. Individuals that have been convinced by the member to become club members are referred to herein as the member's “associates”. An associate of the member that purchased in the previous time period in an amount that exceeds a second threshold value is referred to herein as a “loyal associate”. In this embodiment, a member, in addition to the self-discount mentioned above, receives a discount on his purchases during the present time period based upon the purchase amounts of his associates during the previous time period. This discount is referred to herein as the “member's associate discount”. In this embodiment, the value of the purchases during the previous time period of all of the member's associates (loyal and not loyal) are totaled and divided by the number of the member's loyal associates during the same time period. This ratio is referred to herein as the “upper limit for the associates discount”. A member is entitled to an associates discount if he has purchased in excess of the first threshold value during the previous month. The member's associate discount during the present time period is based upon the value during the present time period of the member's purchases in excess of the first threshold value up to a maximum amount equal to the upper limit for the associates discount. The value of the discount is equal to a basic rate (e.g. 4%) times the number of loyal associates. For example, if the first threshold value is $800, and the upper limit is $1000, and the member has made purchases totaling $900 in the present period, the member receives a discount on the $100 that he has purchased in excess of the first threshold ($800), where the rate of the discount is a basic rate (e.g. 4%) time the number of loyal associates. If the member purchases during the present time period in excess of the upper limit (e.g. $1,100), he would receive the discount only on the difference between the upper limit and the first threshold.

### BRIEF DESCRIPTION OF THE DRAWINGS

In order to understand the invention and to see how it may be carried out in practice, a preferred embodiment will now be described, by way of non-limiting example only, with reference to the accompanying drawing, in which:

FIG. 1 shows a system in accordance with one embodiment of the invention;

FIG. 2 shows a terminal of the embodiment of FIG. 1;

FIG. 3 shows a controller of the embodiment of FIG. 1;

FIG. 4 shows a flow chart for an update program in accordance with one embodiment of the invention;

FIG. 5 shows a flow chart for a method of calculatng a discount in accordance with one embodiment of the invention; and

FIG. 6 shows a flow chart for a method of calculating a discount in accordance with another embodiment of the invention

### DETAILED DESCRIPTION OF THE INVENTION

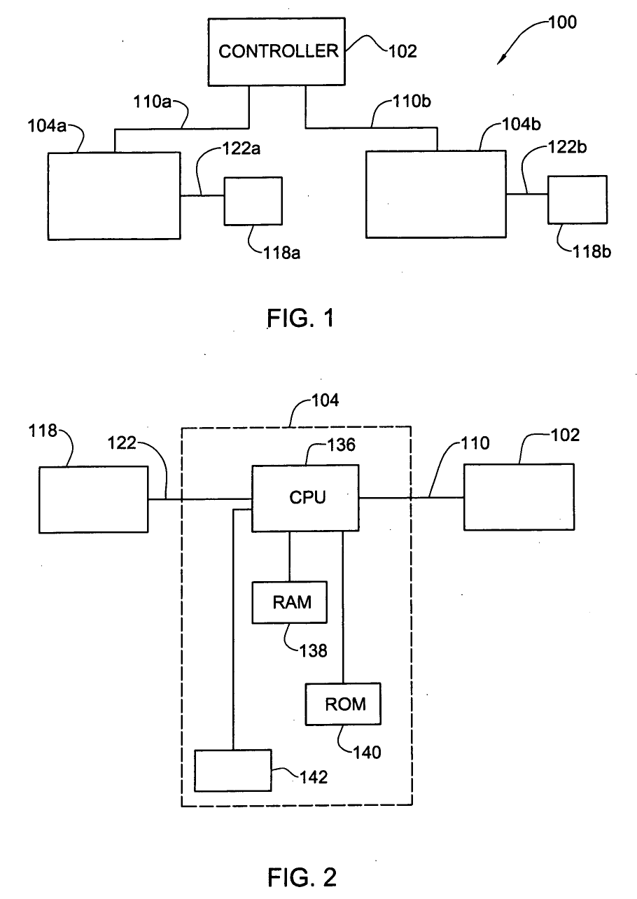

FIG. 1 shows a schematic diagram of a system 100 for recording transactions made by a plurality of club members who are frequent patrons of a business establishment, and calculating a discount to which a member is entitled, in accordance with the invention. The phrase “business establishment” is used here in the broad sense, and may include several outlets of a chain, or several different businesses or business types that have decided to cooperate between themselves, so that all purchases made at the different cooperating businesses are considered equivalent for the calculation of the discounts.

The system includes a controller 102 that communicates with one or more terminals 104 via a respective data link 110. In FIG. 1, two terminals 104a and 104b are shown. This is by way of example only, and the system may have any number of terminals 104. The terminals 104 are typically located at a position in the business establishment where a member pays for his purchases, such as the check out counter of a supermarket.

Each terminal 104 has an associated input device 118. The input device 118 is used to input data identifying a club member that has come to pay for his purchase. Each member may be provided, for example, with a card having a magnetic strip carrying data indicative of the identity of the member and his account number in the club. In this case, the input device 118 is a card reader, and data are input by swiping the member's card in the card reader. A terminal 104 communicates with its associated input device 118 via a respective data link 122. Alternatively, the member may be provided with a card bearing a unique bar code. In this case, the input device 118 is an optical bar code scanner that may be the same scanner used to input prices of purchased items. The input device 118 transmits this coded information to terminal 104.

The terminals 104 and the controller 102 may be located at a single site, in which case the communication 110 between the controller 102 and the terminals 104 may a local access network (LAN). Alternatively, The terminals 104 and the controller 102 may be or may be located at different sites of the business establishments in which case the communication links 110 between the controller 102 and the terminals 104 may be a remote network connection. Such network connections include computer networks (such as the Internet or an Intranet) and telephone networks (such as a public switched telephone network). The connection may be a wireless connection such as a radio-based connection.

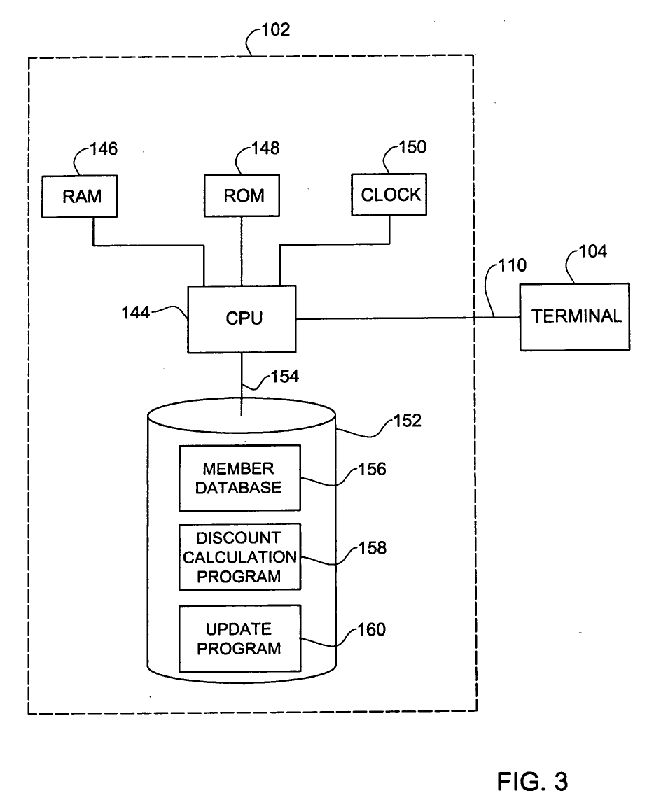

FIG. 2 shows the architecture of the terminal 104. The terminal 104 comprises a data processing system including a central processing unit (CPU) 136, a random access memory unit (RAM) 138, a read-only memory unit (ROM) 140. The terminal 104 is adapted to receive data signals from the input device 118 and process the information in combination with data signals received from the controller 102 via link 110.

When a member makes a purchase, his identity is input to the CPU 136 from the input device 118. The member's identity is transmitted to the controller 102. Controller 102 stores data relating to the account of each club member, as explained in detail below. The controller 102 determines whether the member is entitled to a discount on his present purchase based upon the discount calculated at the end of the previous time period. (e.g. at the end of the last calendar month). The controller 102 then transmits to the terminal 104 the amount of the discount the member has earned, and this amount is deducted from the value of the member's present purchase. The value of the present purchase (after any discounts have been deducted) are then transmitted to the controller 102 which stores the data in the member's account The controller 102 also determines whether the member making the purchase is an associate of another member, and if so records the amount of the present purchase in the account of the member of whom he is an associate.

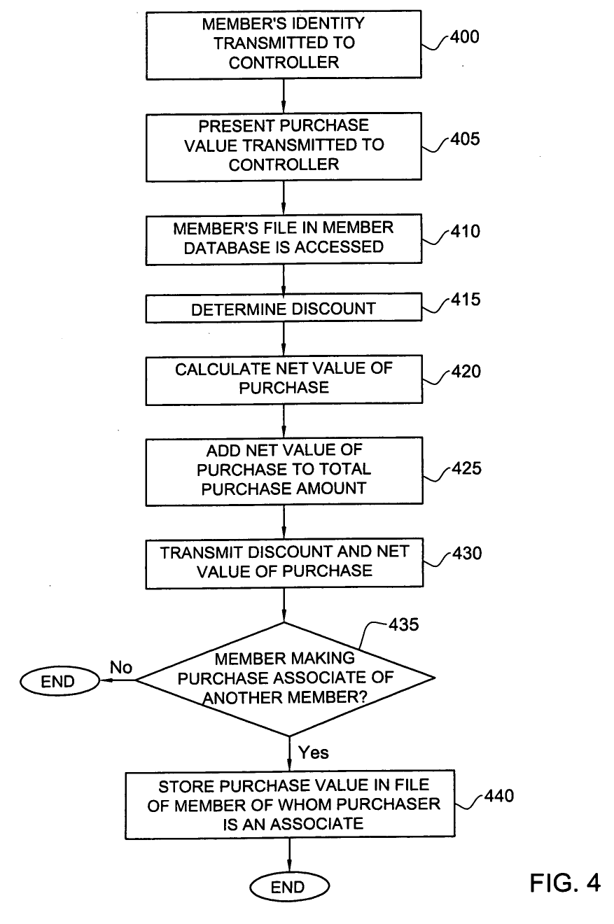

FIG. 3 shows a schematic diagram of the controller 102. The controller 102 is a data processing system comprising a central processing unit (CPU) 144, a random access memory unit (RAM) 146, a read-only memory unit (ROM) 148, a clock 150, and a data storage device 152. CPU 144 is configured with communications equipment such as telephony communications and network communications equipment to communicate with the terminals 104 via data link 110. CPU 144 is also coupled to the data storage device 152 via a bus 154.

The data storage device 152 stores a member database 156. The member database 156 maintains a record for each member including information relating to the value of the member's unused discount earned during the previous time period, the total value of his purchases so far during the present time period as well as the total value of the purchases of each of his associates so far during the present time period. Each time that a member makes a purchase, the CPU 144 executes the update program 160, which updates the entries in the member's file in accordance with the value of the purchase, as described in detail below. At the end of each time period, CPU 144 executes the discount calculation program 158 which, as described in detail below, calculates the discount earned by each member during the time period.

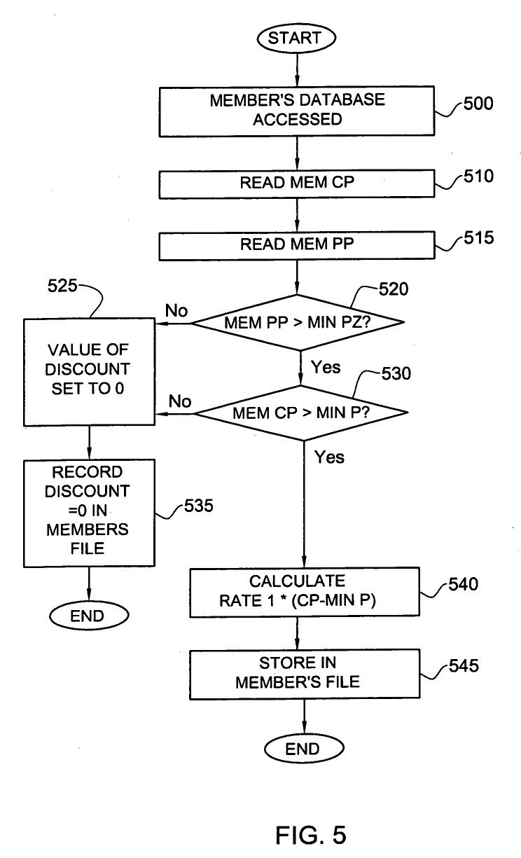

FIG. 4 shows a flow chart for the update program 160. As stated above, this program is executed each time that a member makes a purchase. In step 400, the member's identity is transmitted from the terminal 104 to the controller 102 and is stored in the RAM 146. In step 405, the value of the member's present purchase is transmitted from the terminal 104 and is stored in the RAM 146. In step 410, the member's file in the member database 152 is accessed. In step 410, the member's file is scanned and the amount of the discount to which the member is entitled on the present purchase is determined. The discount to which the member is entitled is then subtracted from the value of the present purchase to produce the net value of he present purchase (step 415). The net value of the present purchase (the original value less the discount) is then calculated (step 420). Then in step 425, the net value of the present purchase is added to the previously stored value of the total amount of purchases made by the member so far during the present time period. The new total is stored in the member's file in the member database 156, together with the date and time of the purchase, and this is transmitted to the terminal 104 together with the amount of the discount (step 430).

In step 435 it is determined whether the member making the purchase is an associate of another member. If no, the process terminates. If yes, then in step 440, the net value of the purchase is stored in the file of the member of which the purchasing member is an associate, and the process terminates.

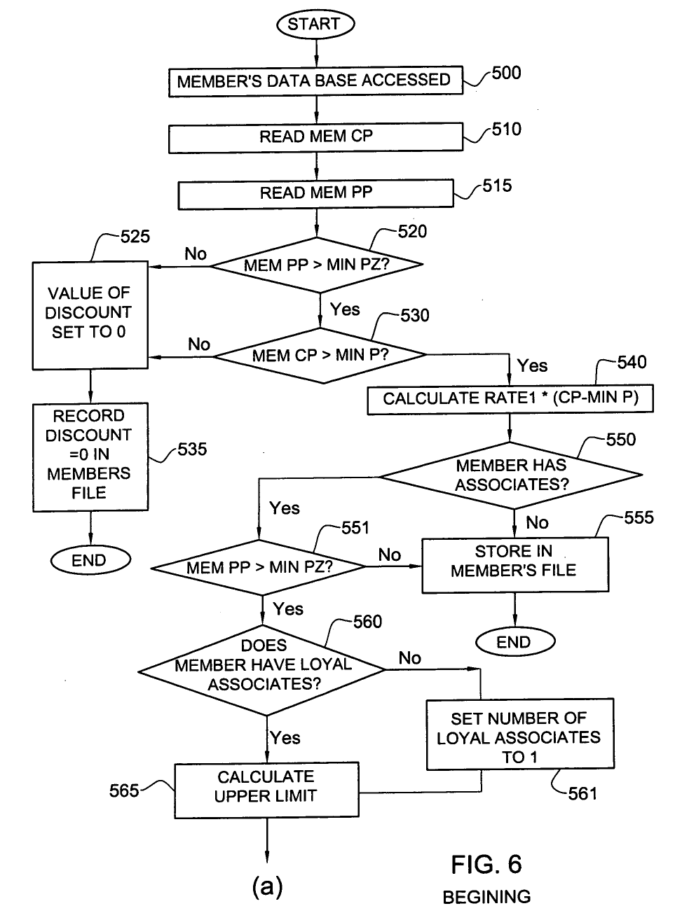

FIG. 5 shows a flow chart for the discount calculation program 158 in accordance with one embodiment of the invention. As stated above, this program is executed for each club member at the end of every time period (referred to herein as the “recent time period”). In the embodiment of FIG. 5, the member receives only a self-discount and does not receive an associate discount.

In step 500, a member's file in the member database 156 is accessed. In step 510 the total value of the member's purchases during the recent time period (referred to hereinbelow as “Mem CP”) is read. In step 515, the value of the member's purchases during the time period that preceeded the recent time period (referred to hereinbelow as “Mem PP”) is read. It is then determined whether Mem PP exceeds a third threshold value referred to herein as Min PZ (step 520). If no, the value of the discount to which the member is entitled on his purchases made during the recent time period is set to zero (step 525). Then in step 530 this is recorded in the member's file in the member database 156, and the process terminates.

If it is determined at step 520 that the total value of the member's purchases during the previous time period exceeded the third threshold (Mem PP>Min PZ), then in step 535 it is determined whether the total value of the member's purchases during the recent time period exceeded a first threshold referred to herein as Min P (step 530). If no, the process proceeds to step 525. If yes, then in step 540 the difference between the first threshold (Min P) and the total value of the member's purchases during the recent time period (Mem CP) is calculated and multiplied by the first discount rate (RATE1) (e.g. 4%), to produce the member's self-discount. In the embodiment of FIG. 5, the member's self-discount is the discount to which the member has earned on his purchases in the subsequent time period, and in step 545, the earned discount is stored in the member's file in the member database 156.

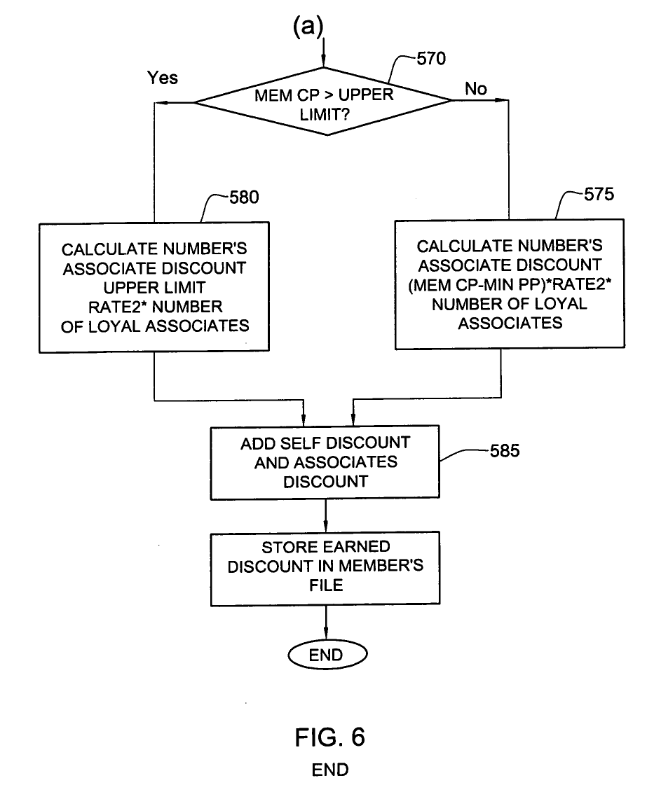

FIG. 6 shows a flow chart for the discount calculation program 158 in accordance with another embodiment of the invention. In this embodiment the member receives both a self-discount and an associate's discount. The initial steps in the embodiment of FIG. 6 are identical to those of the embodiment of FIG. 5, and are identified by the same numeral.

In the embodiment of FIG. 6, after the member's self-discount is calculated in step 540, it is determined from the member's file in the member database 156 whether the member has any associates (step 550). If no, then also in this case the member's earned discount is the member's self-discount and in step 555 the earned discount is stored in the member's file in the member's database 156, and the process terminates.

If however, at step 550 it is determined that the member has associates, then in step 551 it is determined whether Mem P>PZ. If no, then the process returns to step 555. If yes, then in step 560 it is determined from the member's file whether any of his associates were loyal associates during the recent time period. As defined above, a loyal associate is an associate of the member that purchased in the previous time period in an amount that exceeds the second threshold value. If at step 560 it is determined that the member does not have any loyal associates, then at step 561 the number of loyal associates is set to 1, and the process proceeds to step 565. If, however, at step 560 it is determined that the member has loyal associates, then in step 565 the total value of the of all of his associates (loyal and not loyal) during the previous month is calculated, and this sum is divided by the number of loyal associates (this ratio is referred to herein as “the upper limit”). In 570, it is determined whether the member's purchases in the present time period (mem CP) is greater than the upper limit. If no, then in step 575, the member's associate discount is calculated as the (Mem CP−Min P) times a second basic rate (RATE2) times the number of loyal associates. If at step 570 it is determined that the member's purchases in the present time period is not greater than the upper limit, then in step 580 the member's associate discount is calculated as the Upper limit times RATE2 times the number of loyal associates. Then in step 585 the member's earned discount is calculated as the sum of his self-discount and his associate discount. The earned discount is stored in the member's file (step 590) and the process terminates.

1. A method for calculating a discount to a customer at a business establishment comprising:
(a) determining the value of a parameter Mem PP, wherein Mem PP is a total purchase amount made by the customer at the establishment in a first time period
(b) determining the value of a parameter Mem CP, wherein Mem CP is a total purchase amount made by a customer at the establishment in a second time period, the second time period being subsequent to the first period; and
(c) calculating the discount using Mem PP and Mem CP.

2. The method according to claim 1 wherein the discount is calculated to be zero if Mem PP does not exceed a first predetermined amount Min PZ.

3. The method according to claim 1 wherein calculating the discount includes calculating Mem CP−Min P when Mem PP exceeds a predetermined amount Min PZ, wherein Min P is a predetermined amount.

4. The method according to claim 3 wherein calculating the discount is obtained using an algorithm involving the algebraic expression:
(Mem CP−Min P)*RATE1
wherein RATE1 is a predetermined discount rate.

5. The method according to claim 1 further comprising for each of one or more individuals associated with the customer:
(a) determining the value of a parameter Assoc PP, wherein Assoc PP is a total purchase amount of the individual at the establishment in the first time period;
(b) determining the value of a parameter Assoc CP, wherein is a total purchase amount of the individual at the establishment in the second time period;
and wherein calculating the discount further includes calculating an associates discount Assoc Disc, wherein Assoc Disc is obtained in a calculation involving the Assoc PP and Assoc CP of at least one of the individuals associated with the customer.

6. The method according to claim 5 wherein calculating the discount involves
(a) Calculating an upper limit, wherein the upper limit is a sum of the Assoc PP of all individuals associated with the customer divided by a number n, wherein n is the number of individuals associated with the customer for which Assoc PP exceeds a third predetermined threshold value;
(b) If Mem CP>upper limit, calculating Assoc Disc using an algorithm involving the algebraic expression upper limit*RATE2*n, wherein RATE2 is a second discount rate;
(c) If Mem CP<upper limit, calculating Assoc Disc using an algorithm involving the algebraic expression (Mem CP−Min PP)*RATE2*n.

7. The method according to claim 6 wherein the discount is obtained using an algorithm involving the algebraic expression (Mem CP−Min P)*RATE1+Assoc discount.

8. The method according to claim 1 further including recording in a customer database containing a file for the customer, any one or more of the following:
(a) a current total purchase value of the customer at the business establishment during the present time period; and
(b) a current total purchase value of one or more individuals associated with the customer at the business establishment during the present time period.

9. The method according to claim 8 further comprising updating the customer's file in the database when the customer makes a purchase at the business establishment.

10. The method according to claim 8 further comprising updating the customer's file in the database when an individual associated with the customer makes a purchase at the business establishment.

11. A system for calculating a discount to a customer at a business establishment comprising a processor configured to:
(a) determine the value of a parameter Mem PP, wherein Mem PP is a total purchase amount made by the customer at the establishment in a first time period;
(b) determine the value of a parameter Mem CP, wherein Mem CP is a purchase amount made by a customer at the establishment in a second time period, the second time period being subsequent to the first period; and
(c) calculate the discount using an algorithm involving Mem PP and Mem CP.

12. The system according to claim 8 wherein the processor is configured to calculate the discount to be zero if Mem PP does not exceed a first predetermined amount Min PZ.

13. The system according to claim 10 wherein the processor is configured to calculate the discount using an algorithm that includes calculating Mem CP−Min P when Mem PP exceeds the first predetermined amount Min PZ.

14. The system according to claim 12 wherein calculating the processor is configured to calculate the discount using an algorithm involving the algebraic expression:
(Mem CP−Min P)*RATE1
wherein RATE1 is a predetermined discount rate.

15. The system according to claim 10 wherein the processor is configured, for each of one or more individuals associated with the customer,
(a) to determine the value of a parameter Assoc PP, wherein Assoc PP is a total purchase amount of the individual at the establishment in the first time period;
(b) to determine the value of a parameter Assoc CP, wherein Assoc CP is a total purchase amount of the individual at the establishment in the second time period
and wherein the processor is configured to calculate the discount using an algorithm including calculating an associates discount Assoc Disc, wherein Assoc Disc is obtained in a calculation involving the Assoc PP and Assoc CP of at least one of the individuals associated with the customer.

16. The system according to claim 14 wherein the processor is configured to calculate the discount using an algorithm involving:
(a) Calculating an upper limit wherein the upper limit is a sum of the Assoc PP of all individuals associated with the customer divided by a number n, wherein n is the number of individuals associated with the customer for which Assoc PP exceeds a third predetermined threshold value;
(b) If Mem CP>upper limit, calculating Assoc Disc using an algorithm involving the algebraic expression upper limit*RATE2*n, wherein RATE2 is a second discount rate;
(c) If Mem CP<upper limit, calculating Assoc Disc using an algorithm involving the algebraic expression (Mem CP−Min PP)*RATE2*n.

17. The system according to claim 15 wherein the discount is obtained using an algorithm involving the algebraic expression (Mem CP−Min P)*RATE1+Assoc discount.

18. The system according to claim 15 further including a customer database, the customer database containing a file for each of a plurality of customers, a customer file including entries of any one or more of the following:
(c) a current total purchase value of the customer at the business establishment during the present time period; and
(d) a current total purchase value of one or more individuals associated with the customer at the business establishment during the present time period.

19. The system according to claim 17 wherein the processor is further configured to update a customer's file in the database when the customer makes a purchase at the business establishment.

20. The system according to claim 17 wherein the processor is further configured to update a customer's file in the database when an individual associated with the customer makes a purchase at the business establishment.
